(19) United States
(12) Patent Application Publication
(10) Pub. No.: US 2012/0032659 A1
(43) Pub. Date: Feb. 9, 2012

(54) POWER SUPPLY DEVICE

(76) Inventors: Eiichiro KUROSAWA, Osaka (JP); Jun Tanaka, Osaka (JP)

(21) Appl. No.: 13/190,112

(22) Filed: Jul. 25, 2011

(30) Foreign Application Priority Data
Aug. 6, 2010 (JP) 2010-177133

(51) Int. Cl. G05F 1/10

(52) U.S. Cl. 323/282

(57) ABSTRACT

A power supply device for transforming a DC input voltage by switching charging/discharging of an inductor, and obtaining a DC output voltage by smoothing the transformed voltage by a capacitor, includes: a transistor for synchronous rectification coupled between the inductor and the capacitor; a current determination circuit for determining whether a current flowing through the transistor is less than a lower-limit current; and a control circuit for operating the transistor in a constant current operation while the current flowing through the transistor is greater than the lower-limit current and operating the transistor in a rectification operation when the current is less than the lower-limit current, based on a determination result of the current determination circuit.

### CROSS-REFERENCE TO RELATED APPLICATION

This application claims priority to Japanese Patent Application No. 2010-177133 filed on Aug. 6, 2010, the disclosure of which including the specification, the drawings, and the claims is hereby incorporated by reference in its entirety.

### BACKGROUND

The present disclosure relates to a power supply device, and more particularly to a switching converter.

Switching converters have high-efficiency power conversion characteristics, and many have been used as power supply devices in various electronic devices using batteries as DC input power supplies. A switching converter switches the charging/discharging of an inductor, thereby transforming a DC input voltage to generate a DC output voltage. In terms of the operation principle, a switching converter needs rectification means and voltage smoothing means. In addition to a diode, a switching transistor may be used as the rectification means. A capacitor is typically used as the voltage smoothing means.

In a switching converter immediately after the start-up, the capacitor of the smoothing means is not sufficiently charged, an inrush current may flow due to output short-circuiting, thereby damaging the circuit. In view of this, at start-up, a transistor for synchronous rectification is operated in a constant current operation to sufficiently charge the capacitor, and after the output voltage reaches the target voltage, the transistor is switched to the synchronous rectification mode to operate the switching converter in normal operation (see Japanese Laid-Open Patent Publication No. 2008-92639 for example).

### SUMMARY

With a conventional switching converter, the capacitor is charged with a constant current through a constant current operation of the transistor immediately after the start-up, and as the capacitor is charged, the output voltage increases and the drain-source voltage of the transistor decreases. As a result, the charging current gradually decreases, and it takes time before the output voltage reaches the target voltage. That is, it takes a very long time before the switching converter is brought into a normal operation state. Particularly, if the capacity of the capacitor is increased for the purpose of improving the driving capacity, for example, the start-up time of the switching converter may become even longer.

With the switching converter of the present disclosure, it is possible to shorten the start-up time.

As an example, a power supply device for transforming a DC input voltage by switching charging/discharging of an inductor, and obtaining a DC output voltage by smoothing the transformed voltage by a capacitor, includes: a transistor for synchronous rectification coupled between the inductor and the capacitor; a current determination circuit for determining whether a current flowing through the transistor is less than a lower-limit current; and a control circuit for operating the transistor in a constant current operation while the current flowing through the transistor is greater than the lower-limit current and operating the transistor in a rectification operation when the current is less than the lower-limit current, based on a determination result of the current determination circuit.

With this, the transistor for synchronous rectification is operated in a constant current operation, and when the drain-source current thereof is less than the lower-limit current, it is switched to a rectification operation. That is, the power supply device can be switched to the normal operation mode at a point where the output voltage has increased to a certain degree.

For example, the current determination circuit includes: a first resistive load one end of which is coupled to the DC input voltage; a first constant current source coupled to the other end of the first resistive load; a second resistive load one end of which is coupled to the DC output voltage; a second constant current source coupled to the other end of the second resistive load; and a comparator for comparing a potential at the other end of the first resistive load with a potential at the other end of the second resistive load. Alternatively, the current determination circuit includes: a resistive load one end of which is coupled to the DC input voltage; a constant current source coupled to the other end of the resistive load; and a comparator for comparing a potential at the other end of the resistive load with the DC output voltage. Alternatively, the current determination circuit includes: a current generation circuit for generating a copy current in proportion to the current flowing through the transistor; and a comparison circuit for comparing the copy current with the lower-limit current.

### BRIEF DESCRIPTION OF THE DRAWINGS

FIG. 1 is a block diagram showing a configuration of a power supply device according to a first embodiment.

FIG. 2 is a block diagram showing a configuration according to a variation of the power supply device of FIG. 1.

FIG. 3 is a block diagram showing a configuration of a power supply device according to a second embodiment.

FIG. 4 is a block diagram showing another configuration of the power supply device of FIG. 3.

FIG. 5 is a block diagram showing another configuration of the power supply device of FIG. 3.

FIG. 6 is a block diagram showing another configuration of the power supply device of FIG. 3.

### DETAILED DESCRIPTION

### First Embodiment

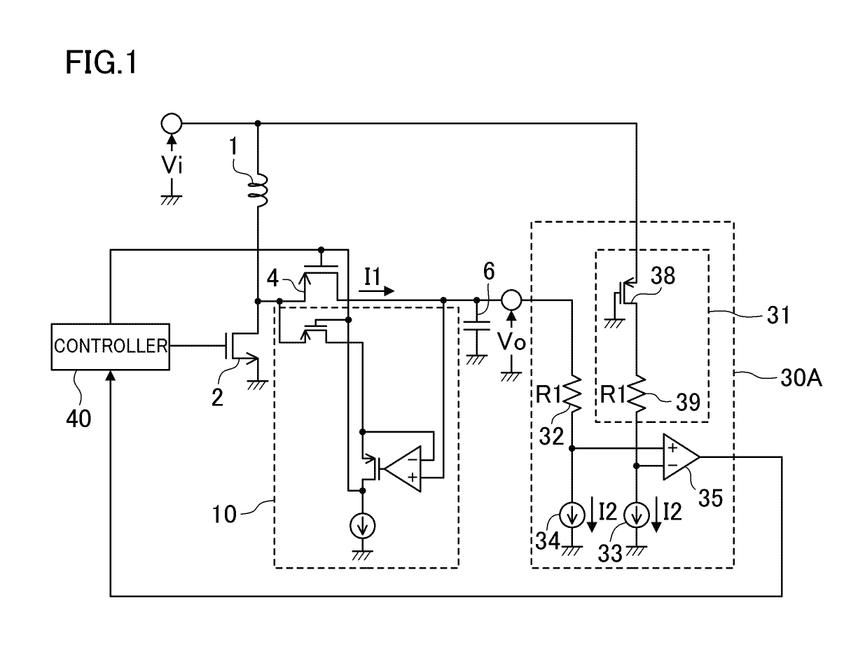

FIG. 1 is a block diagram showing a configuration of a power supply device according to a first embodiment. A power supply device according to the present embodiment is a step-up converter for boosting a DC input voltage Vi by switching the charging/discharging of an inductor 1 by a switching element 2 and rectifying and smoothing the DC input voltage through a transistor 4 and a capacitor 6, thereby generating a DC output voltage Vo.

The transistor 4 is a transistor for synchronous rectification, and performs a constant current operation by controlling a controller 40 to charge the capacitor 6 at the start-up of the power supply device. A current control circuit 10 determines the current to flow through the transistor 4 during a constant current operation.

A current determination circuit 30A determines whether the current flowing through the transistor 4 is less than the lower-limit current. For example, where the current flowing through the transistor 4 during a constant current operation is 1 A, the lower-limit current is preferably set to about 0.4 A, taking into consideration the operation margin of the transistor 4. The current determination circuit 30A may be formed by a resistive load 31 one end of which is coupled to the voltage Vi, a constant current source 33 coupled to the other end of the resistive load 31, a resistive load 32 one end of which is coupled to the voltage Vo, a constant current source 34 coupled to the other end of the resistive load 32, and a comparator 35 for comparing the potential at the other end of the resistive load 31 with the potential at the other end of the resistive load 32. The output current of the constant current source 33 and the output current of the constant current source 34 are the same. The resistive load 32 may be formed by a single resistor element.

The resistive load 31 may be formed by a transistor 38 and a resistor element 39 which are coupled in series. The transistor 38 is biased so that the drop voltage is a voltage represented by the product between the ON resistance of the transistor 4 and 0.4 A which is the lower-limit current. The resistance values of the resistor element 39 and the resistive load 32 are set to be equal to each other. The transistor 38 is the same PMOS transistor as the transistor 4, and therefore has the same temperature characteristics as the transistor 4. That is, in response to temperature fluctuations, the transistor 4 and the transistor 38 undergo the same characteristics changes and thus the same voltage fluctuations. Note that the transistor 38 may be omitted. In such a case, the resistance value of the resistor element 39 is set to be larger than the resistance value of the resistive load 32.

Now, Vo=Vi−Ron1×I1 holds,

where Ron1 is the ON resistance of the transistor 4, I1 is the current flowing through the transistor 4, R1 is the resistance value of the resistive load 32 and the resistor element 39, and I2 is the output current value of the constant current source 33, 34.

Therefore, the voltage of the non-inverting input terminal of the comparator 35 is

Vi−Ron1×I1−R1×I2.

The voltage of the inverting input terminal of the comparator 35 is

Vi−Ron2×I2−R1×I2,

where Ron2 is the ON resistance of the transistor 38.

Based on the expressions above, the current determination circuit 30A outputs the H level when I1<(Ron2/Ron1)×I2 and the L level otherwise.

Based on the output of the current determination circuit 30A, the controller 40 controls the switching element 2 and the transistor 4. Particularly, the controller 40 switches the operation of the transistor 4 between the constant current operation and the rectification operation by applying a bias voltage to the gate and the back gate of the transistor 4 in accordance with the output of the current determination circuit 30A. Specifically, the controller 40 operates the transistor 4 in a constant current operation when the output of the current determination circuit 30A is at the L level and operates the transistor 4 in a rectification operation when the output is at the H level.

Next, an operation of the power supply device according to the present embodiment will be described. At the start-up of the power supply device, since the voltage Vo is substantially zero, the output of the current determination circuit 30A is at the L level. Therefore, the controller 40 operates the transistor 4 in a constant current operation. Thus, the capacitor 6 is charged with a constant current, thus increasing the voltage Vo. I1 decreases as the voltage Vo increases, and when I1 is less than the lower-limit current, the output of the current determination circuit 30A is turned to be the H level, and the operation of the transistor 4 is switched to the rectification operation by the controller 40. Thus, the power supply device is ready to supply power to a load (not shown).

As described above, according to the present embodiment, the operation of the transistor 4 is switched to the rectification operation when the current flowing through the transistor 4 becomes less than the lower-limit current, and it is therefore possible to shorten the start-up time of the power supply device.

—Variation—

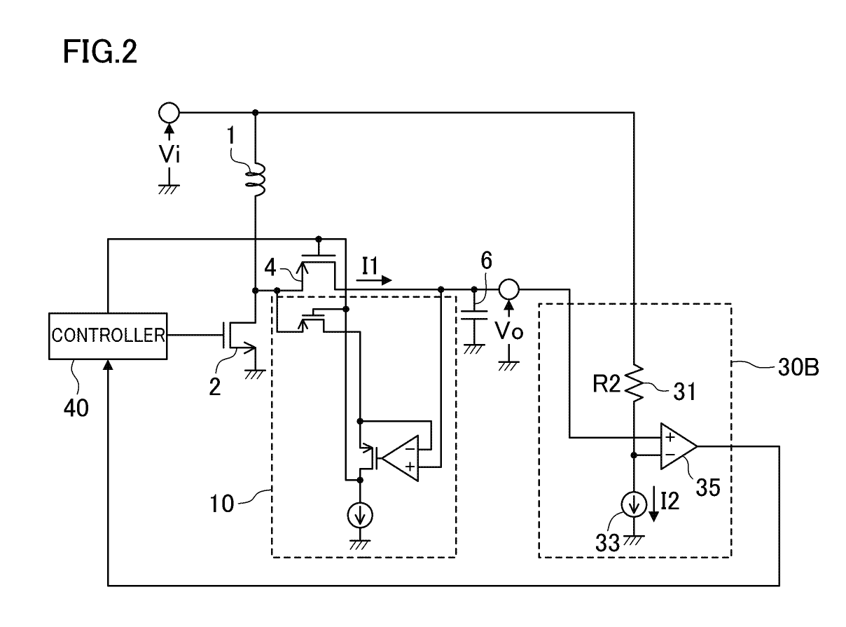

FIG. 2 is a block diagram showing a configuration of a power supply device according to a variation of the first embodiment. The power supply device of FIG. 2 is similar to that of FIG. 1 except that the resistive load 32, the constant current source 34 and the resistor element 39 are omitted, and the resistive load 31 is formed by a single resistor element 31.

Here, the voltage of the non-inverting input terminal of the comparator 35 is

Vi−Ron1×I1.

The voltage of the inverting input terminal of the comparator 35 is

Vi−R2×I2

where R2 is the resistance value of the resistor element 31.

Therefore, a current determination circuit 30B outputs the H level when I1<(R2/Ron1)×I2 holds and the L level otherwise.

### Second Embodiment

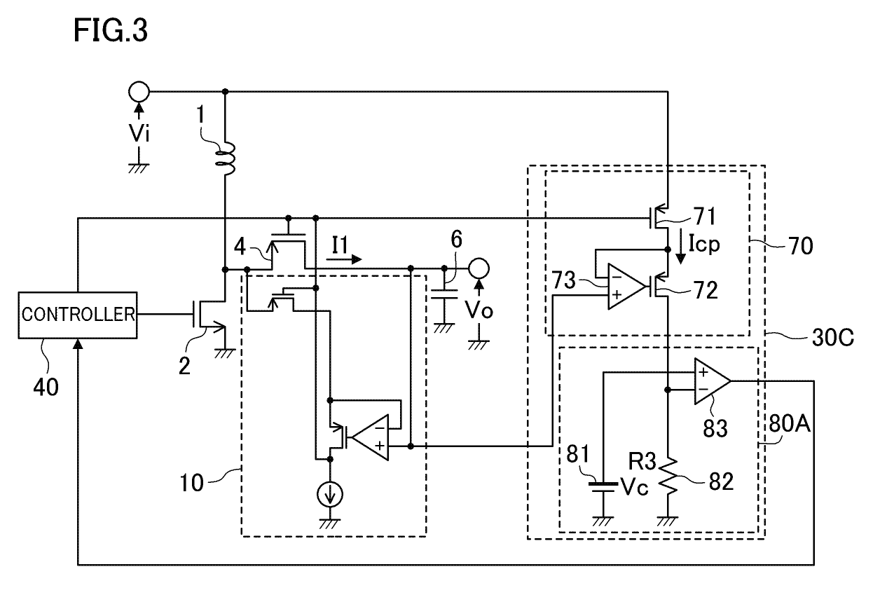

FIG. 3 is a block diagram showing a configuration of a power supply device according to a second embodiment. Differences from the first embodiment will now be described.

A current determination circuit 30C may be formed by a current generation circuit 70 for generating a current Icp which is a copy current in proportion to the current flowing through the transistor 4, and a comparison circuit 80A for comparing Icp with the lower-limit current. The current generation circuit 70 may be formed by a transistor 71, a transistor 72 and a differential amplifier 73. The transistor 71, having a size 1/M that of the transistor 4, shares the gate electrode with the transistor 4, and the source thereof is coupled to the voltage Vi. The source of the transistor 72 is coupled to the drain of the transistor 71, and the gate thereof is coupled to the output of the differential amplifier 73. The drain of the transistor 4 is coupled to the non-inverting input terminal of the differential amplifier 73, and the drain of the transistor 71 is coupled to the inverting input terminal. With such a configuration, Icp which is equal to I1 times 1/M flows through the transistor 71.

The comparison circuit 80A may be formed by a power supply 81 for generating the reference voltage Vc, a resistive load 82 receiving Icp supplied to one end thereof, and a comparator 83 for comparing the potential at one end of the resistive load 82 with the voltage Vc. The resistive load 82 may be formed by a resistor element. The voltage Vc is a voltage of a magnitude in accordance with the lower-limit current (e.g., 0.4 A).

Here, the voltage of the non-inverting input terminal of the comparator 83 is

R3×I1/M

where R3 is the resistance value of the resistive load 82.

Therefore, the current determination circuit 30C outputs the H level when I1<(Vc/R3)×M holds and the L level otherwise.

As described above, according to the present embodiment, the operation of the transistor 4 is switched to the rectification operation when the current flowing through the transistor 4 becomes less than the lower-limit current, and it is therefore possible to shorten the start-up time of the power supply device.

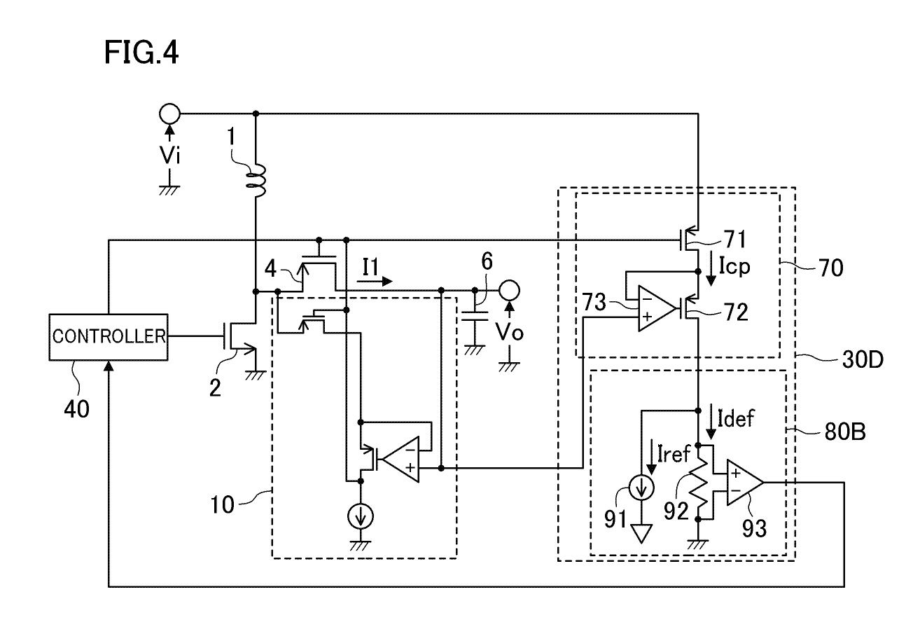

Note that a current determination circuit 30D shown in FIG. 4 may be employed in place of the current determination circuit 30C. A comparison circuit 80B is formed by a constant current source 91 coupled to the output terminal of the current generation circuit 70 for outputting the reference current Iref of a magnitude in accordance with the lower-limit current, a resistive load 92 receiving the differential current Idef between Icp and Iref supplied to one end thereof, and a polarity detection circuit 93 for detecting the polarity of the voltage across the resistive load 92. The resistive load 92 may be formed by a resistor element.

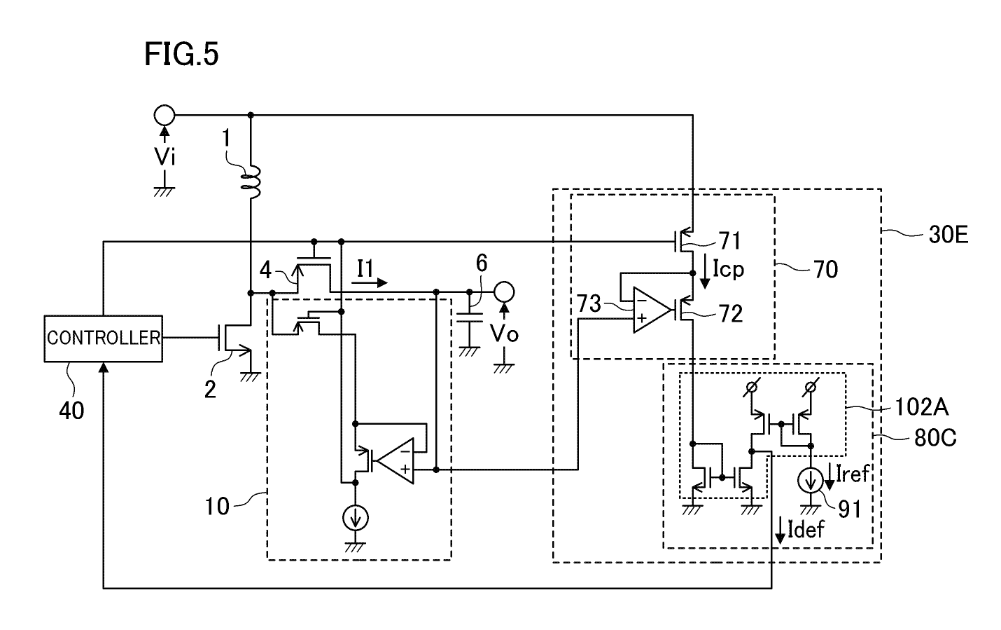

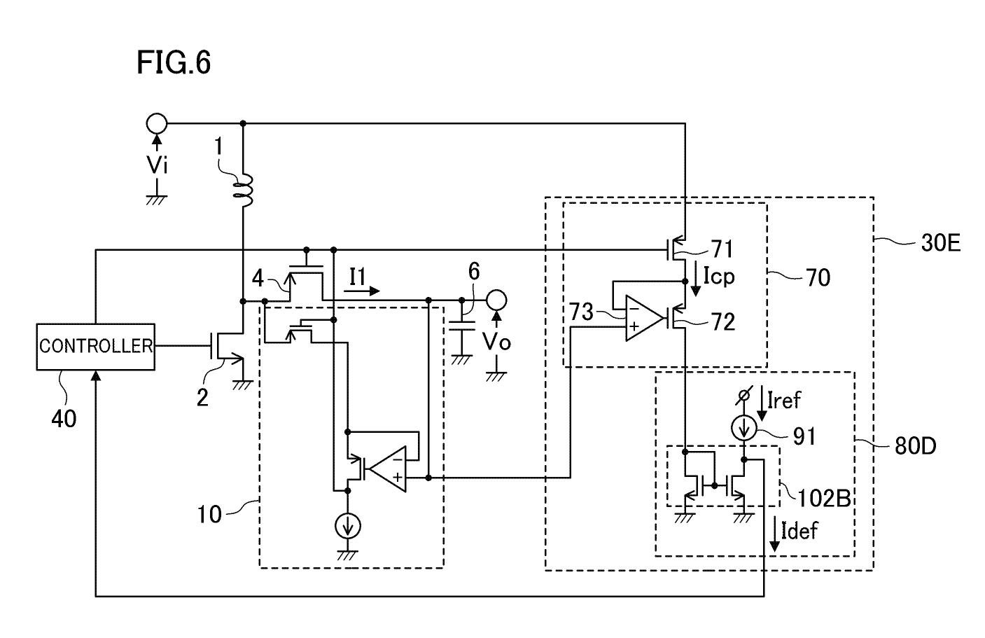

Alternatively, a current determination circuit 30E shown in FIG. 5 may be employed. A comparison circuit 80C may be formed by the constant current source 91 and a differential current generation circuit 102A. The differential current generation circuit 102A may be formed by two current mirror circuits which generate, from Icp and Iref, the differential current Idef between Icp and Iref. Alternatively, as shown in FIG. 6, a differential current generation circuit 102B of a comparison circuit 80D may be formed by a single current mirror circuit which generates Idef from Icp and Iref. Note that since the comparison circuit 80C, 80D outputs a current, the controller 40 needs to control the transistor 4 while determining the direction of Idef. With these configurations, the comparison circuit 80C, 80D no longer needs a comparator, allowing for a reduction in the circuit area.

Note that while the power supply device has been described as a step-up converter in the embodiment above, it may be formed as a step-down converter.

What is claimed is:

1. A power supply device for transforming a DC input voltage by switching charging/discharging of an inductor, and obtaining a DC output voltage by smoothing the transformed voltage by a capacitor, comprising:
a transistor for synchronous rectification coupled between the inductor and the capacitor;
a current determination circuit for determining whether a current flowing through the transistor is less than a lower-limit current; and
a control circuit for operating the transistor in a constant current operation while the current flowing through the transistor is greater than the lower-limit current and operating the transistor in a rectification operation when the current is less than the lower-limit current, based on a determination result of the current determination circuit.

2. The power supply device of claim 1, wherein the current determination circuit includes:
a first resistive load one end of which is coupled to the DC input voltage;
a first constant current source coupled to the other end of the first resistive load;
a second resistive load one end of which is coupled to the DC output voltage;
a second constant current source coupled to the other end of the second resistive load; and
a comparator for comparing a potential at the other end of the first resistive load with a potential at the other end of the second resistive load.

3. The power supply device of claim 2, wherein the first resistive load includes:
a transistor whose source is coupled to the DC input voltage; and
a resistor element one end of which is coupled to a drain of the transistor.

4. The power supply device of claim 1, wherein the current determination circuit includes:
a resistive load one end of which is coupled to the DC input voltage;
a constant current source coupled to the other end of the resistive load; and
a comparator for comparing a potential at the other end of the resistive load with the DC output voltage.

5. The power supply device of claim 1, wherein the current determination circuit includes:
a current generation circuit for generating a copy current in proportion to the current flowing through the transistor; and
a comparison circuit for comparing the copy current with the lower-limit current.

6. The power supply device of claim 5, wherein the comparison circuit includes:
a power supply for generating a reference voltage of a magnitude in accordance with the lower-limit current;
a resistive load receiving the copy current supplied to one end thereof; and
a comparator for comparing a potential at one end of the resistive load with the reference voltage.

7. The power supply device of claim 5, wherein the comparison circuit includes:
a constant current source coupled to an output end of the current generation circuit for outputting a reference current of a magnitude in accordance with the lower-limit current;
a resistive load receiving a differential current between the copy current and the reference current supplied to one end thereof; and
a polarity detection circuit for detecting a polarity of a voltage across the resistive load.

8. The power supply device of claim 5, wherein the comparison circuit includes:
a constant current source for outputting a reference current of a magnitude in accordance with the lower-limit current; and
a differential current generation circuit for generating a differential current between the copy current and the reference current,
wherein the control circuit controls the transistor in accordance with a direction of the differential current.
